(19) United States
(12) Patent Application Publication
(10) Pub. No.: US 2025/0061856 A1
(43) Pub. Date: Feb. 20, 2025

(54) PIXEL CIRCUIT AND DISPLAY DEVICE INCLUDING THE SAME

(71) Applicant: Samsung Display Co., Ltd., Yongin-Si (KR)

(72) Inventor: SANG YONG NO, Yongin-si (KR)

(21) Appl. No.: 18/760,033

(22) Filed: Jul. 1, 2024

(30) Foreign Application Priority Data
Aug. 14, 2023 (KR) 10-2023-0106314

(51) Int. Cl. G09G 3/3233

(52) U.S. Cl. CPC G09G 3/3233; G09G 2300/0819; G09G 2300/0852; G09G 2300/0861; G09G 2320/0233; G09G 2320/045

(57) ABSTRACT

A pixel circuit connects one terminal of a second capacitor to a line of an anode initialization gate signal rather than an anode of a light emitting element such that a change of a gate-source voltage of a first transistor is prevented. The change of the gate-source voltage of the first transistor is prevented, and thus a change of a driving current generated by the first transistor is prevented. Therefore, any damage due to a deterioration of the light emitting element receiving the driving current is prevented, and a luminance accuracy of the light emitting element is preserved.

This application claims priority under 35 USC § 119 to Korean Patent Application No. 10-2023-0106314 filed on Aug. 14, 2023 in the Korean Intellectual Property Office (KIPO), the entire disclosure of which is incorporated by reference herein.

### BACKGROUND

### 1. Field

Embodiments of the present inventive concept relate to a pixel circuit and a display device including the same. More particularly, embodiments of the present inventive concept relate to a pixel circuit and a display device for preventing a deterioration of a light emitting element.

### 2. Description of the Related Art

Generally, a display device includes a display panel and a display panel driver. The display panel includes gate lines, data lines, emission lines and pixel circuits. The display panel driver includes a gate driver for providing gate signals to the gate lines, a data driver for providing data voltages to the data lines, an emission driver for providing emission signals to the emission lines, and a driving controller for controlling the gate driver, the data driver, and the emission driver.

Each of the pixel circuits includes a light emitting element. The light emitting element may deteriorate with usage depending on a level of a voltage of an anode of the light emitting element. If a degree of the deterioration is severe, the light emitting element may be damaged. When the light emitting element is damaged, a luminance accuracy of the light emitting element may be compromised.

### SUMMARY

Embodiments of the present inventive concept provide a pixel circuit for preventing the deterioration of a light emitting element.

Embodiments of the present inventive concept provide a display device including the display circuit.

In an embodiment of a pixel circuit according to the present inventive concept, the pixel circuit comprises a first transistor configured to generate a driving current, a light emitting element including an anode connected to a second terminal of the first transistor and a cathode, a second transistor connected to provide a data voltage to a gate terminal of the first transistor in response to a write gate signal, a third transistor connected to provide a ground voltage to the anode in response to an anode initialization gate signal, a first capacitor including a first terminal connected to a first terminal of the first transistor and a second terminal connected to the gate terminal of the first transistor, and a second capacitor including a first terminal connected to the gate terminal of the first transistor and a second terminal receiving the anode initialization gate signal.

In an embodiment, a back gate terminal of the first transistor may receive a first power supply voltage.

In an embodiment, the pixel circuit may further comprise a fourth transistor connected to provide a first power supply voltage to the first terminal of the first transistor in response to an emission signal.

In an embodiment, the first to fourth transistors may be a P-type transistor.

In an embodiment, an inactive level of the anode initialization gate signal may be adjusted.

In an embodiment, in a first period, the emission signal and the anode initialization gate signal may have an active level, and the write gate signal may have an inactive level.

In an embodiment, in the first period, the first terminal of the first transistor may be initialized to the first power supply voltage, and the anode may be initialized to the ground voltage.

In an embodiment, in a second period after the first period, the write gate signal and the anode initialization gate signal may have the active level, and the emission signal may have the inactive level.

In an embodiment, in the second period, the second transistor may be configured to provide the data voltage to the gate terminal of the first transistor, and when the fourth transistor is turned off, the first capacitor is configured to store a threshold voltage of the first transistor.

In an embodiment, in a third period after the second period, the anode initialization gate signal may have the active level, and the emission signal and the write gate signal may have the inactive level.

In an embodiment, in the third period, the first capacitor may maintain a threshold voltage of the first transistor.

In an embodiment, in a fourth period after the third period, the emission signal may have the active level, and the write gate signal and the anode initialization gate signal may have the inactive level.

In an embodiment, in the fourth period, the light emitting element may emit light based on the driving current.

In an embodiment, the first transistor may include the gate terminal connected to a first node, the first terminal connected to a second node, and the second terminal connected to a third node, the light emitting element may include the anode connected to the third node and the cathode receiving a second power supply voltage, the second transistor may include a gate terminal receiving the write gate signal, a first terminal connected to a data line providing the data voltage, and the second terminal connected to the first node, the third transistor may include a gate terminal receiving the anode initialization gate signal, a first terminal connected to the third node, and a second terminal receiving the ground voltage, the fourth transistor may include a gate terminal receiving the emission signal, a first terminal receiving the first power supply voltage, and a second terminal connected to the second node, the first capacitor may include the first terminal connected to the second node and the second terminal connected to the first node, and the second capacitor may include the first terminal connected to the first node and the second terminal receiving the anode initialization gate signal.

In an embodiment, the pixel circuit may further comprise a third capacitor including a first terminal receiving the first power supply voltage and a second terminal connected to the gate terminal of the first transistor.

In an embodiment, the third capacitor may include the first terminal receiving the first power supply voltage and the second terminal connected to the first node.

In an embodiment of a display device according to the present inventive concept, the display device comprises a display panel including a pixel circuit. The pixel circuit includes a first transistor configured to generate a driving current, a light emitting element including an anode connected to a second terminal of the first transistor and a cathode, a second transistor connected to provide a data voltage to a gate terminal of the first transistor in response to a write gate signal, a third transistor connected to provide a ground voltage to the anode in response to an anode initialization gate signal, a first capacitor including a first terminal connected to a first terminal of the first transistor and a second terminal connected to the gate terminal of the first transistor, and a second capacitor including a first terminal connected to the gate terminal of the first transistor and a second terminal receiving the anode initialization gate signal.

In an embodiment, a back gate terminal of the first transistor may receive a first power supply voltage.

In an embodiment, the pixel circuit may further include a fourth transistor connected to provide a first power supply voltage to the first terminal of the first transistor in response to an emission signal.

In an embodiment, the first to fourth transistors may be a P-type transistor.

According to the display panel and the display device including the pixel circuit according to the embodiments, the pixel circuit may connect one terminal of the second capacitor to a line of the anode initialization gate signal rather than the anode of the light emitting element such that a change of a gate-source voltage of the first transistor may be prevented. Preventing the change of the gate-source voltage of the first transistor may prevent a change in the driving current generated by the first transistor. Therefore, any damage due to a deterioration of the light emitting element receiving the driving current may also be prevented, preserving a luminance accuracy of the light emitting element.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram illustrating a display device according to embodiments of the present inventive concept;

FIG. 2 is a circuit diagram illustrating an example of a pixel circuit of FIG. 1;

FIG. 3 is a timing diagram illustrating an example of driving a pixel circuit of FIG. 2;

FIG. 4 is a timing diagram illustrating an example in which a pixel circuit of FIG. 2 operates in a first period of FIG. 3;

FIG. 5 is a circuit diagram illustrating an example in which a pixel circuit of FIG. 2 operates in a first period of FIG. 3;

FIG. 6 is a timing diagram illustrating an example in which a pixel circuit of FIG. 2 operates in a second period of FIG. 3;

FIG. 7 is a circuit diagram illustrating an example in which a pixel circuit of FIG. 2 operates in a second period of FIG. 3;

FIG. 8 is a timing diagram illustrating an example in which a pixel circuit of FIG. 2 operates in a third period of FIG. 3;

FIG. 9 is a circuit diagram illustrating an example in which a pixel circuit of FIG. 2 operates in a third period of FIG. 3;

FIG. 10 is a timing diagram illustrating an example in a pixel circuit of FIG. 2 operates in a fourth period of FIG. 3;

FIG. 11 is a circuit diagram illustrating an example in which a pixel circuit of FIG. 2 operates in a fourth period of FIG. 3;

FIG. 12 is a circuit diagram illustrating an example of a pixel circuit of FIG. 1;

FIG. 13 is a block diagram illustrating an electronic device;

FIG. 14 is a diagram illustrating an embodiment in which the electronic device of FIG. 13 is implemented as a smart phone; and

FIG. 15 is a diagram illustrating an embodiment in which the electronic device of FIG. 13 is implemented as a head mounted display device.

### DETAILED DESCRIPTION OF THE EMBODIMENTS

Hereinafter, the present disclosure will be described in more detail with reference to the accompanying drawings.

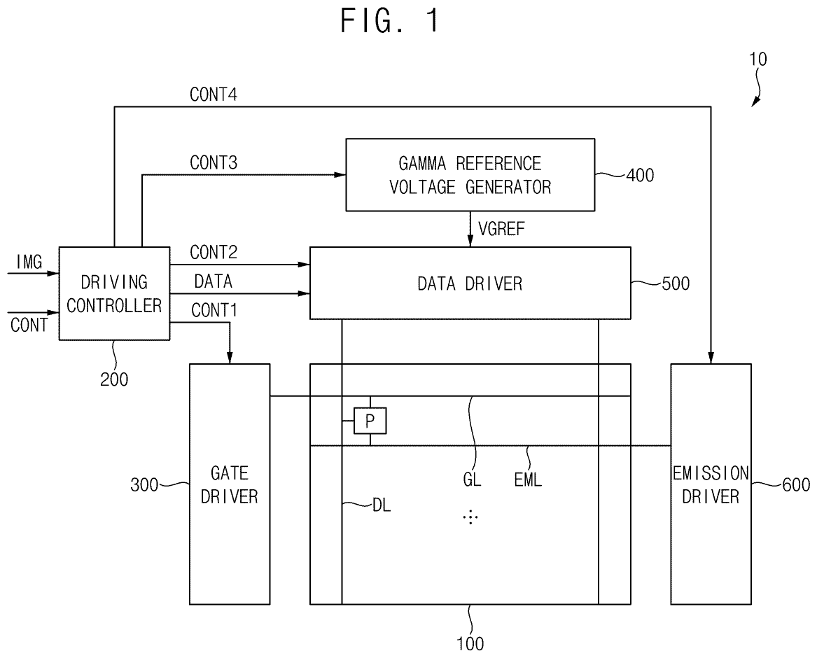

FIG. 1 is a block diagram illustrating a display device according to embodiments of the present inventive concept.

Referring to FIG. 1, a display device 10 may include a display panel 100 and a display panel driver. The display panel driver may include a driving controller 200, a gate driver 300, a gamma reference voltage generator 400, a data driver 500, and an emission driver 600.

For example, the driving controller 200 and the data driver 500 may be integrally formed with each other. For example, the driving controller 200, the gamma reference voltage generator 400, and the data driver 500 may be integrally formed with each other. For example, the driving controller 200, the gate driver 300, the gamma reference voltage generator 400, and the data driver 500 may be integrally formed with each other. For example, the driving controller 200, the gate driver 300, the gamma reference voltage generator 400, the data driver 500, and the emission driver 600 may be integrally formed with each other. A driving module in which at least the driving controller 200 and the data driver 500 are integrally formed may be referred to as a timing controller embedded data driver (TED).

The display panel 100 may include a display region displaying an image and a peripheral region disposed adjacent to the display region.

For example, the display panel 100 may be an organic light emitting diode display panel including an organic light emitting diode. For another example, the display panel 100 may be a quantum-dot organic light emitting diode display panel including an organic light emitting diode and a quantum-dot color filter. For another example, the display panel 100 may be a quantum-dot nano-light emitting diode display panel including a nano-light emitting diode and a quantum-dot color filter. For another example, the display panel 100 may be a liquid crystal display panel including a liquid crystal layer.

The display panel 100 may include gate lines GL, data lines DL, emission lines EML, and pixel circuits P electrically connected to the gate lines GL, the data lines DL, and the emission lines EML. The gate lines GL may extend in a first direction, the data lines DL may extend in a second direction crossing the first direction, and the emission lines EML may extend in the first direction.

The driving controller 200 may receive input image data IMG and an input control signal CONT from an external device (not shown). For example, the input image data IMG may include red image data, green image data, and blue image data. According to the embodiments, the input image data IMG may further include white image data. For another example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, a fourth control signal CONT4, and a data signal DATA based on the input image data IMG and the input control signal CONT.

The driving controller 200 may generate the first control signal CONT1 for controlling an operation of the gate driver 300 based on the input control signal CONT and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT and output the third control signal CONT3 to the gamma reference voltage generator 400.

The driving controller 200 may generate the fourth control signal CONT4 for controlling an operation of the emission driver 600 based on the input control signal CONT and output the fourth control signal CONT4 to the emission driver 600.

The gate driver 300 may generate gate signals for driving the gate lines GL in response to the first control signal CONT1 received from the driving controller 200. The gate driver 300 may output the gate signals to the gate lines GL.

In an embodiment, the gate driver 300 may be integrated on the peripheral region of the display panel 100.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

In an embodiment, the gamma reference voltage generator 400 may be disposed in the driving controller 200 or in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into an analog type data voltage by using the gamma reference voltage VGREF. The data driver 500 may output the data voltage to the data line DL.

The emission driver 600 may generate emission signals for driving the emission lines EML in response to the fourth control signal CONT4 received from the driving controller 200. The emission driver 600 may output the emission signals to the emission lines EML.

In an embodiment, the emission driver 600 may be integrated into the peripheral region of the display panel 100. In an embodiment, the emission driver 600 may be mounted on the peripheral region of the display panel 100.

In FIG. 1, for a convenience of a description, the gate driver 300 may be disposed on a first side of the display panel 100 and the emission driver 600 may be disposed on a second side of the display panel 100. The present invention is not limited thereto. For example, both the gate driver 300 and the emission driver 600 may be disposed on the first side of the display panel 100. For example, both the gate driver 300 and the emission driver 600 may be disposed on both sides of the display panel 100. For example, the gate driver 300 and the emission driver 600 may be formed integrally.

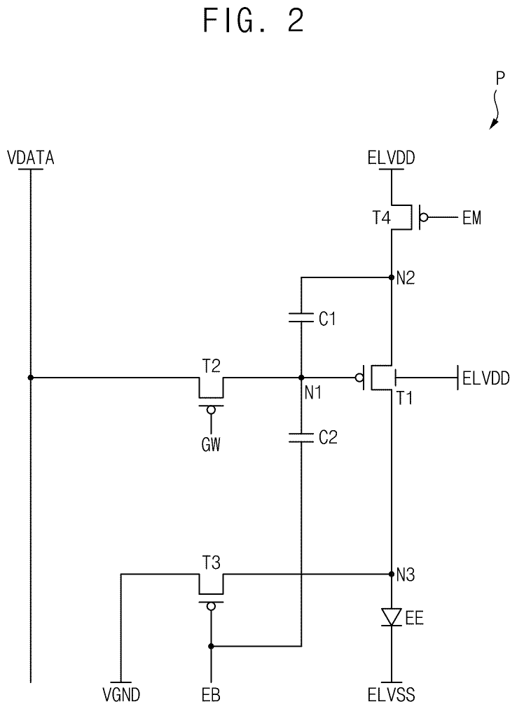

FIG. 2 is a circuit diagram illustrating an example of a pixel circuit of FIG. 1.

Referring to FIGS. 1 and 2, a pixel circuit P may include a first transistor T1 which generates a driving current, a light emitting element EE which includes an anode connected to a second terminal of the first transistor T1 and a cathode, a second transistor T2 which provides a data voltage VDATA to a gate terminal of the first transistor T1 in response to a write gate signal GW, a third transistor T3 which provides a ground voltage VGND in response to an anode initialization gate signal EB, a first capacitor C1 which includes a first terminal connected to a first terminal of the first transistor T1 and a second terminal connected to the gate terminal of the first transistor T1, a second capacitor C2 which includes a first terminal connected to the gate terminal of the first transistor T1 and a second terminal receiving the anode initialization gate signal EB. The pixel circuit P may further include a fourth transistor T4 which provides a first power supply voltage ELVDD to the first terminal of the first transistor T1 in response to an emission signal EM.

The first transistor T1 may have the gate terminal connected to a first node N1, the first terminal connected to a second node N2, and the second terminal connected to a third node N3. The first transistor T1 may further include a back gate terminal receiving the first power supply voltage ELVDD. When the emission signal EM has an active level, a voltage of the back gate terminal of the first transistor T1 and a voltage of the first terminal of the first transistor T1 may be equal to the first power supply voltage ELVDD. Therefore, the first transistor T1 may include the back gate terminal such that a body effect in which a threshold voltage of the first transistor T1 changes may be minimized. That is, an ability of the pixel circuit P to compensate for the threshold voltage may be improved.

The light emitting element EE may include the anode connected to the third node N3 and the cathode receiving a second power supply voltage ELVSS. The second power supply voltage ELVSS may be lower than the first power supply voltage ELVDD. For example, the second power supply voltage ELVSS may be −4V. In this embodiment, the light emitting element EE may be an ultra-small light emitting diode or a micro light emitting diode. A display device including the ultra-small light emitting diode may be a type of a silicon-based display. The silicon-based display may be advantageous for realizing a high integration due to an excellent electrical characteristic of the silicon-based device and an extremely fine device size. However, the present inventive concept is not limited to this. In another embodiment, the light emitting element EE may be an organic light emitting diode.

The second transistor T2 may have a gate terminal receiving the write gate signal GW, a first terminal connected to a data line DL transmitting the data voltage VDATA, and a second terminal connected to the first node N1.

The third transistor T3 may include a gate terminal receiving the anode initialization gate signal EB, a first terminal connected to the third node N3, and a second terminal receiving the ground voltage VGND. For example, the ground voltage VGND may be OV.

The fourth transistor T4 may include a gate terminal receiving the emission signal EM, a first terminal receiving the first power supply voltage ELVDD, and a second terminal connected to the second node N2.

The first capacitor C1 may include the first terminal connected to the second node N2 and the second terminal connected to the first node N1.

The second capacitor C2 may include the first terminal connected to the first node N1 and the second terminal receiving the anode initialization gate signal EB.

In an embodiment, the first transistor T1, the second transistor T2, the third transistor T3, and the fourth transistor T4 may be a P-type transistor. In this case, the first terminals of the first to fourth transistors T1 to T4 may be a source terminal, and the second terminals of the first to fourth transistors T1 to T4 may be a drain terminal. Additionally, the active level may be a low level, and an inactive level may be a high level. For example, when a gate signal applied to a gate terminal of the P-type transistor has the low level, the P-type transistor may be turned on. For example, when the gate signal applied to the gate terminal of the P-type transistor has the high level, the P-type transistor may be turned off.

However, the present inventive concept is not limited to this. In an embodiment, the first to fourth transistors T1 to T4 may be a N-type transistor. In this case, the active level may be the high level, and the inactive level may be the low level. For example, when a gate signal applied to a gate terminal of the N-type transistor has the high level, the P-type transistor may be turned on. For example, when the gate signal applied to the gate terminal of the N-type transistor has the low level, the N-type transistor may be turned off.

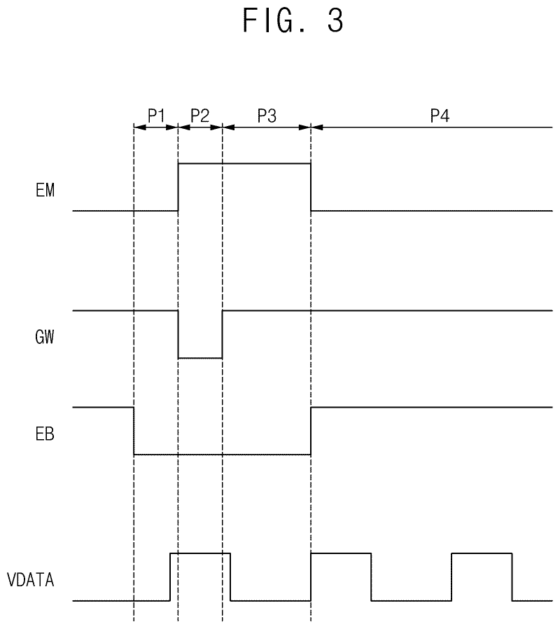

FIG. 3 is a timing diagram illustrating an example of driving a pixel circuit of FIG. 2.

Referring to FIGS. 1 to 3, in a first period P1, the emission signal EM and the anode initialization gate signal EB may have the active level, and the write gate signal GW may have the inactive level.

In a second period P2 after the first period P1, the write gate signal GW and the anode initialization gate signal EB may have the active level, and the emission signal EM may have the inactive level.

In a third period P3 after the second period P2, the anode initialization gate signal EB may have the active level, the emission signal EM and the write gate signal GW may have the inactive level.

In a fourth period P4 after the third period P3, the emission signal EM may have the active level, and the write gate signal GW and the anode initialization gate signal EB have the inactive level.

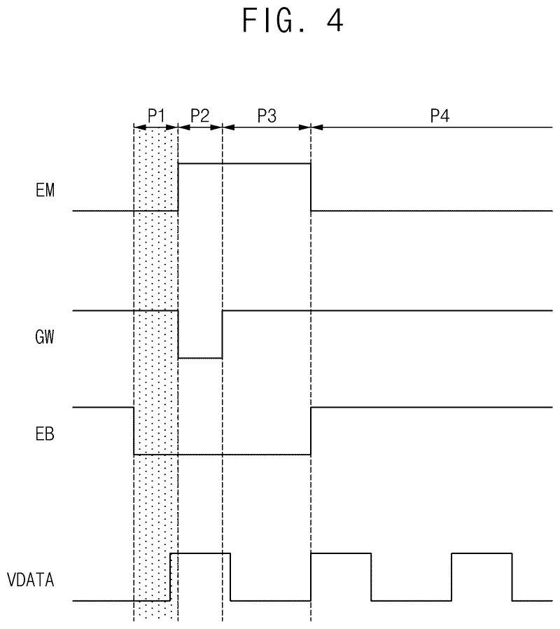

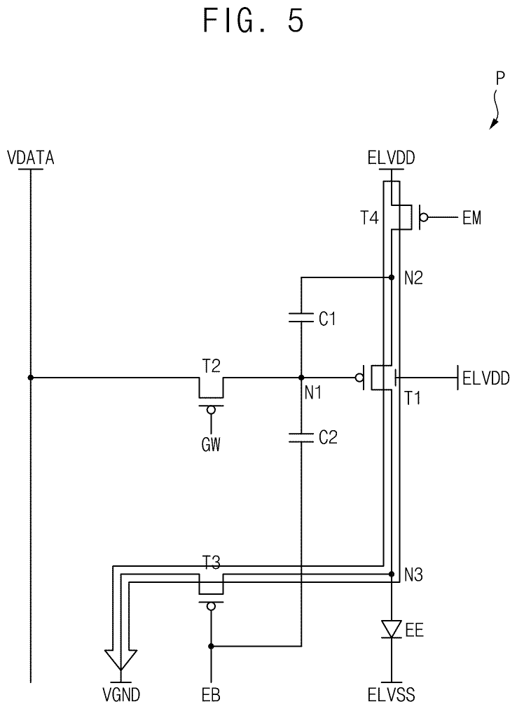

FIG. 4 is a timing diagram illustrating an example in which a pixel circuit of FIG. 2 operates in a first period of FIG. 3. FIG. 5 is a circuit diagram illustrating an example in which a pixel circuit of FIG. 2 operates in a first period of FIG. 3.

Referring to FIGS. 4 and 5, in the first period P1, the third transistor T3 and the fourth transistor T4 may be turned on, and the second transistor T2 may be turned off.

A path may be formed through the fourth transistor T4, the first transistor T1, and the third transistor T3. The first terminal of the first transistor T1 may be initialized through the path. The anode may be initialized through the path. For example, the second node N2 (i.e., the first terminal of the first transistor T1) may be initialized to the first power supply voltage ELVDD. The third node N3 (i.e., the second terminal of the first transistor T1 and the anode) may be initialized to the ground voltage VGND.

Since the anode is initialized to the ground voltage VGND, a light emission of the light emitting element EE due to a leakage current in the pixel circuit P displaying black may be minimized.

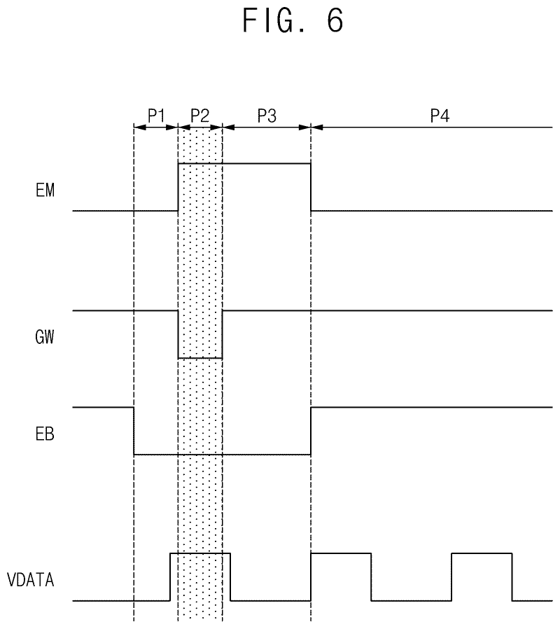

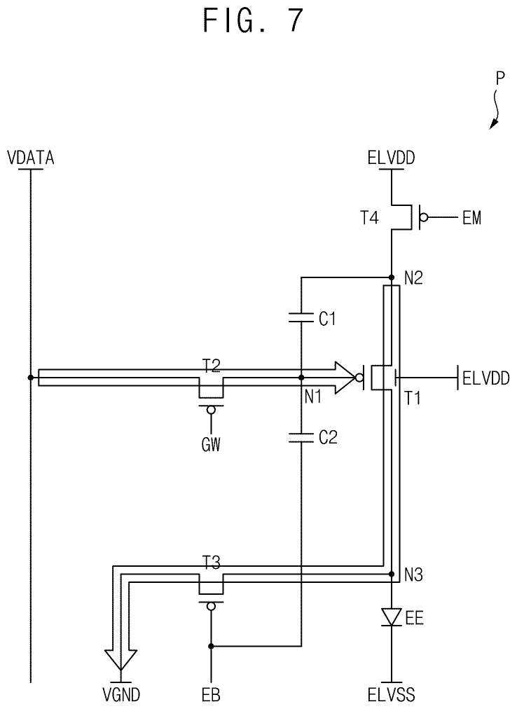

FIG. 6 is a timing diagram illustrating an example in which a pixel circuit of FIG. 2 operates in a second period of FIG. 3. FIG. 7 is a circuit diagram illustrating an example in which a pixel circuit of FIG. 2 operates in a second period of FIG. 3.

Referring to FIGS. 6 and 7, in the second period P2, the second transistor T2 and the third transistor T3 may be turned on, and the fourth transistor T4 may be turned off.

The second transistor T2 may provide the data voltage VDATA to the first node N1 (i.e., the gate terminal of the first transistor T1). Since the second transistor T2 provides the data voltage VDATA to the first node N1 and the fourth transistor T4 is turned off, a voltage of the first node N1 may be the data voltage VDATA, and a voltage of the second node N2 may be VDATA−VTH. Here, VDATA is the data voltage, and VTH is the threshold voltage of the first transistor T1. The first capacitor C1 may store the threshold voltage VTH of the first transistor T1. Accordingly, the threshold voltage of the first transistor T1 may be compensated.

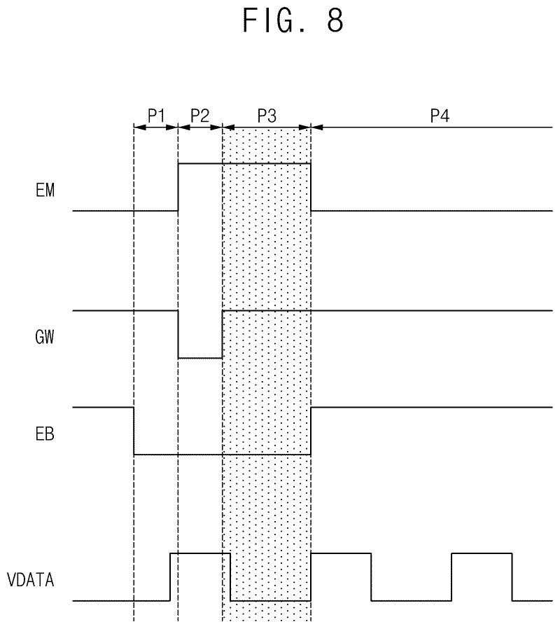

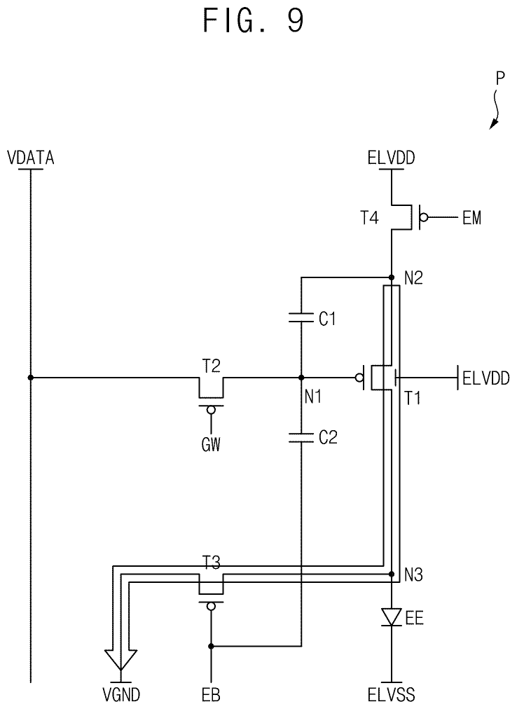

FIG. 8 is a timing diagram illustrating an example in which a pixel circuit of FIG. 2 operates in a third period of FIG. 3. FIG. 9 is a circuit diagram illustrating an example in which a pixel circuit of FIG. 2 operates in a third period of FIG. 3.

Referring to FIGS. 8 and 9, in the third period P3, the third transistor T3 may be turned on, and the second transistor T2 and the fourth transistor T4 may be turned off.

In the third period P3, the first capacitor C1 may maintain the threshold voltage of the first transistor T1 stored in the second period P2. Accordingly, the threshold voltage of the first transistor T1 may be continuously compensated.

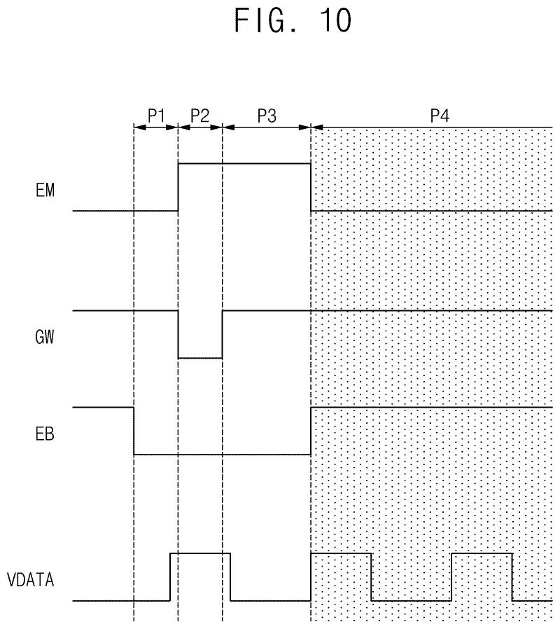

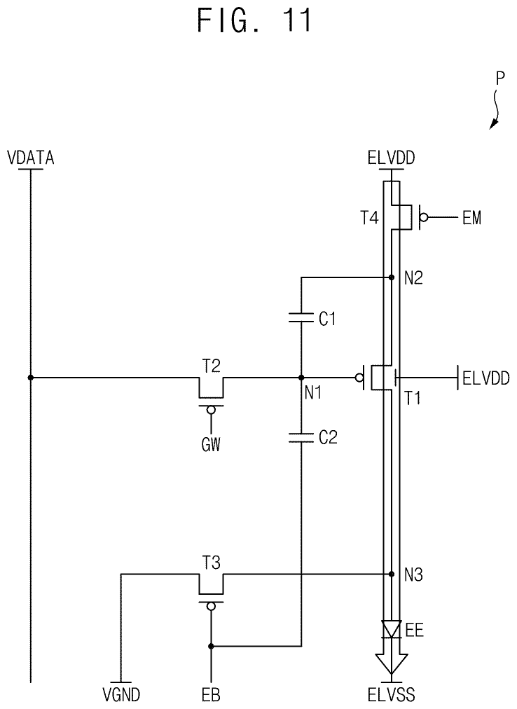

FIG. 10 is a timing diagram illustrating an example in a pixel circuit of FIG. 2 operates in a fourth period P4 of FIG. 3. FIG. 11 is a circuit diagram illustrating an example in which a pixel circuit of FIG. 2 operates in a fourth period of FIG. 3.

Referring to FIGS. 10 and 11, in the fourth period P4, the fourth transistor T4 may be turned on, and the second transistor T2 and the third transistor T3 may be turned off.

The voltage of the first node N1 (i.e., the gate terminal of the first transistor T1) may be determined based on the data voltage VDATA. The driving current may be determined based on a gate-source voltage of the first transistor T1. Therefore, the driving current may be determined based on the voltage of the first node N1, and the light emitting element EE may emit light with a luminance corresponding to the driving current.

Since the voltage of the second node N2 is the first power supply voltage ELVDD and the third transistor T3 is turned off, the voltage of the first node N1 (i.e., the voltage of the gate terminal of the first transistor T1) may be distributed by the first capacitor C1 and the second capacitor C2. Therefore, the voltage of the first node N1 may be VDATA+(ELVDD−VDATA−VTH)×(C_C1)/(C_C1+C_C2)+ΔV_EB×(C_C2)/(C_C1+C_C2) and the voltage of the second node N2 may be the first power supply voltage ELVDD. That is, the gate-source voltage of the first transistor T1 may be −(ELVDD−VDATA−ΔV_EB)×(C_C2)/(C_C1+C_C2)+VTH×(C_C1)/(C_C1+C_C2). A VDATA component of the gate-source voltage of the first transistor T1 may be VDATA×(C_C2)/(C_C1+C_C2), and (C_C2)/(C_C1+C_C2) may be less than 1 such that a data range of the data voltage VDATA may be expanded. Here, ELVDD is the first power supply voltage, VDATA is the data voltage, VTH is the threshold voltage of the first transistor T1, C_C1 is a capacitance of the first capacitor C1, and C_C2 is a capacitance of the second capacitance C2, and ΔV_EB is the difference between the active level of the anode initialization gate signal EB and the inactive level of the anode initialization gate signal EB.

Meanwhile, when the second terminal of the second capacitor C2 is connected to the anode and the light emitting element EE emits light, the light emitting element EE may deteriorate and a voltage of the anode may change. When the voltage of the anode changes, the voltage of the first node N1 may change. When the voltage of the first node N1 changes, the driving current generated by the first transistor T1 may change. Accordingly, a luminance accuracy of the light emitting element EE depending on the data voltage VDATA may be reduced.

The second terminal of the second capacitor C2 may be connected to a line of the anode initialization gate signal EB rather than the anode. That is, the second terminal of the second capacitor C2 may receive the anode initialization gate signal EB. Therefore, while the light emitting element EE emits light, the second terminal of the second capacitor C2 and the anode may not be connected to each other. This disconnect may prevent a decrease of the luminance accuracy of the light emitting element EE based on the first data voltage VDATA.

This effect may be confirmed by the equation for the gate-source voltage of the first transistor T1 described above: “−(ELVDD−VDATA−ΔV_EB)×(C_C2)/(C_C1+C_C2)+VTH×(C_C1)/(C_C1+C_C2)”. While the light emitting element EE emits light, the changed voltage of the anode of the light emitting element EE does not appear in the equation for the gate-source voltage of the first transistor T1, and the anode initialization gate signal EB and the difference between the active level of the anode initialization gate signal EB and the inactive level of the anode initialization gate signal EB appears. In an embodiment, the inactive level of the anode initialization gate signal EB may be adjusted. That is, ΔV_EB may be adjusted.

As such, according to the pixel circuit P and the display device 10 including the pixel circuit P, one terminal of the second capacitor C2 may be connected to the line of the anode initialization gate signal EB rather than the anode of the light emitting element EE such that a change of the gate-source voltage of the first transistor T1 may be prevented. The change of the gate-source voltage of the first transistor T1 may be prevented such that a change of the driving current generated by the first transistor T1 may be prevented. Therefore, any damage due to deterioration of the light emitting element EE which receives the driving current may be prevented, and the luminance accuracy of the light emitting element EE may be improved.

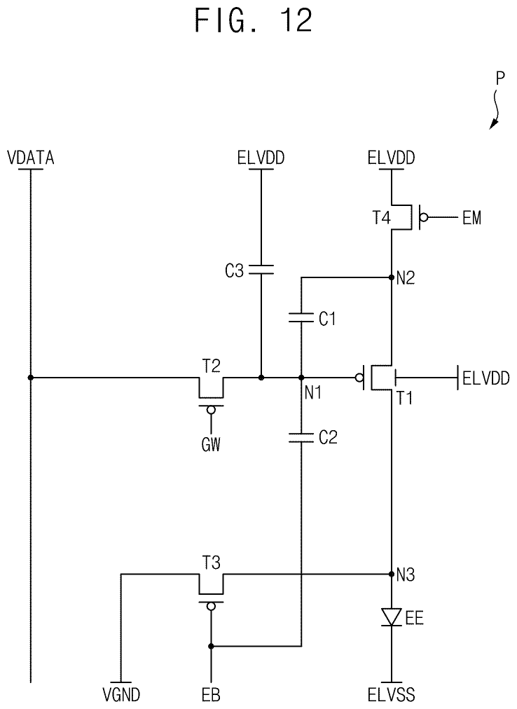

FIG. 12 is a circuit diagram illustrating an example of a pixel circuit of FIG. 1.

A pixel circuit P of FIG. 12 is substantially equal to the pixel circuit P in FIG. 2 except that the pixel circuit P of FIG. 12 further includes a third capacitor C3. Therefore, a description of substantially identical or overlapping configurations and operations will be omitted.

Referring to FIGS. 2 and 12, the pixel circuit P of FIG. 12 may further include the third capacitor C3 including a first terminal receiving the first power supply voltage ELVDD and a second terminal connected to the first node N1, which is not part of the pixel circuit P of FIG. 2.

The pixel circuit P of FIG. 12 may further include the third capacitor C3 such that the data range of the data voltage VDATA may change.

In the second period P2, the second transistor T2 may provide the data voltage VDATA to the first node N1 and the fourth transistor T4 may be turned off such that the voltage of the first node N1 may be the data voltage VDATA, and the voltage of the second node N2 may be VDATA−VTH.

In the fourth period P4, the voltage of the second node N2 may be the first power supply voltage ELVDD and the third transistor T3 may be turned off such that the voltage of the first node N1 (i.e., the gate terminal of the first transistor T1) may be distributed by the first capacitor C1, the second capacitor C2, and the third capacitor C3. Therefore, the voltage of the first node N1 may be VDATA+(ELVDD−VDATA−VTH)×(C_C1)/(C_C1+C_C2+C_C3)+ΔV_EB×(C_C2)/(C_C1+C_C2+C_C3), and the voltage of the second node N2 may be the first power supply voltage ELVDD. That is, the gate-source voltage of the first transistor T1 may be −(ELVDD−VDATA)×(C_C2+C_C3)/(C_C1+C_C2+C_C3)+ΔV_EB×(C_C2)/(C_C1+C_C2+C_C3)+VTH×(C_C1)/(C_C1+C_C2+C_C3). A VDATA component of the gate-source voltage of the first transistor T1 may be VDATA×(C_C2+C_C3)/(C_C1+C_C2+C_C3), and (C_C2+C_C3)/(C_C1+C_C2+C_C3) is less than 1 such that the data range of the data voltage VDATA may be expanded. Here, C_C3 is a capacitance of the third capacitor C3.

As such, according to the pixel circuit P and the display device 10 including the pixel circuit P, one terminal of the second capacitor C2 may be connected to the line of the anode initialization gate signal EB rather than the anode of the light emitting element EE such that a change of the gate-source voltage of the first transistor T1 may be prevented. The change of the gate-source voltage of the first transistor T1 may be prevented such that a change in the driving current generated by the first transistor T1 may be prevented. Therefore, damage due to deterioration of the light emitting element EE which receives the driving current may be prevented, improving the luminance accuracy of the light emitting element EE.

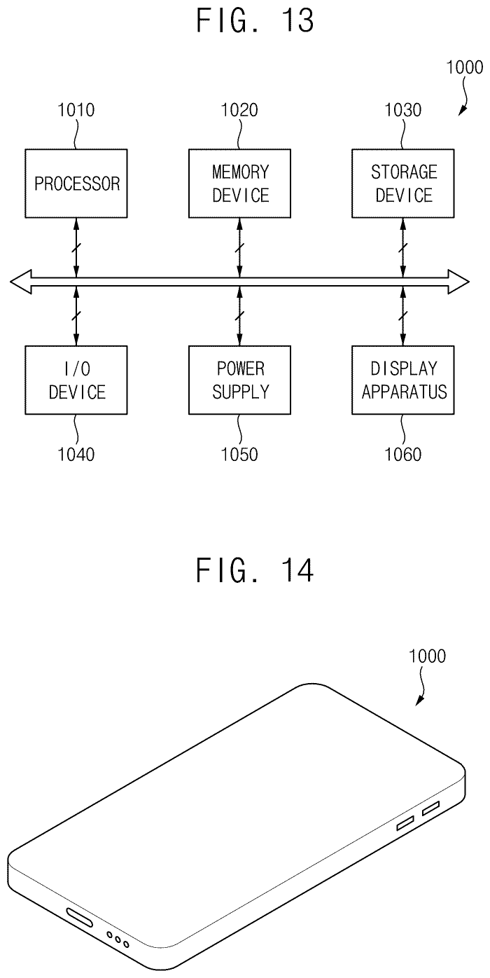

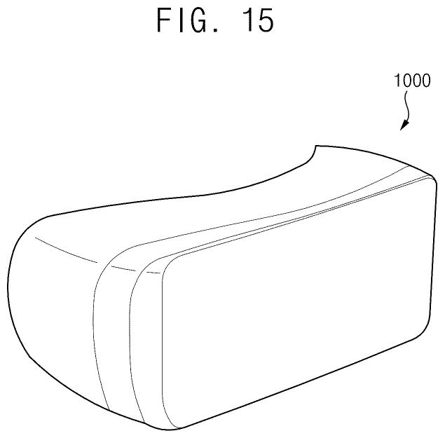

FIG. 13 is a block diagram illustrating an electronic device. FIG. 14 is a diagram illustrating an embodiment in which the electronic device of FIG. 13 is implemented as a smart phone. FIG. 15 is a diagram illustrating an embodiment in which the electronic device of FIG. 13 is implemented as a head mounted display device.

Referring to FIGS. 13 to 15, an electronic device 1000 may include a processor 1010, a memory device 1020, a storage device 1030, an input/output (I/O) device 1040, a power supply 1050, and a display apparatus 1060. The display apparatus 1060 may be the display device 10 in FIG. 1. In addition, the electronic device 1000 may further include a plurality of ports for communicating with a video card, a sound card, a memory card, a universal serial bus (USB) device, other electronic device, and the like.

In an embodiment, as shown in FIG. 14, the electronic device 1000 may be implemented as a smart phone. In another embodiment, as shown in FIG. 15, the electronic device 1000 may be implemented as a head mounted display device. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMID) device, and the like.

The processor 1010 may perform various computing functions. The processor 1010 may be a micro processor, a central processing unit (CPU), an application processor (AP), and the like. The processor 1010 may be coupled to other components via an address bus, a control bus, a data bus, and the like. Further, the processor 1010 may be coupled to an extended bus such as a peripheral component interconnection (PCI) bus.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like.

The I/O device 1040 may include an input device such as a keyboard, a keypad, a mouse device, a touch-pad, a touch-screen, and the like, and an output device such as a printer, a speaker, and the like. In some embodiments, the I/O device 1040 may include the display apparatus 1060.

The power supply 1050 may provide power for operations of the electronic device 1000.

The display apparatus 1060 may be connected to other components through buses or other communication links.

The inventive concepts may be applied to any display device and any electronic device including the touch panel. For example, the inventive concepts may be applied to a mobile phone, a smart phone, a tablet computer, a digital television (TV), a 3D TV, a personal computer (PC), a home appliance, a laptop computer, a personal digital assistant (PDA), a portable multimedia player (PMP), a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A pixel circuit comprising:
a first transistor configured to generate a driving current;
a light emitting element including an anode connected to a second terminal of the first transistor and a cathode;
a second transistor connected to provide a data voltage to a gate terminal of the first transistor in response to a write gate signal;
a third transistor connected to provide a ground voltage to the anode in response to an anode initialization gate signal;
a first capacitor including a first terminal connected to a first terminal of the first transistor and a second terminal connected to the gate terminal of the first transistor; and
a second capacitor including a first terminal connected to the gate terminal of the first transistor and a second terminal receiving the anode initialization gate signal.

2. The pixel circuit of claim 1, wherein a back gate terminal of the first transistor receives a first power supply voltage.

3. The pixel circuit of claim 1, further comprising:
a fourth transistor connected to provide a first power supply voltage to the first terminal of the first transistor in response to an emission signal.

4. The pixel circuit of claim 3, wherein the first to fourth transistors are a P-type transistor.

5. The pixel circuit of claim 1, wherein an inactive level of the anode initialization gate signal is adjusted.

6. The pixel circuit of claim 3, wherein in a first period, the emission signal and the anode initialization gate signal have an active level, and the write gate signal has an inactive level.

7. The pixel circuit of claim 6, wherein, in the first period, the first terminal of the first transistor is initialized to the first power supply voltage, and the anode is initialized to the ground voltage.

8. The pixel circuit of claim 6, wherein in a second period after the first period, the write gate signal and the anode initialization gate signal have the active level, and the emission signal has the inactive level.

9. The pixel circuit of claim 6, wherein, in the second period, the second transistor is configured to provide the data voltage to the gate terminal of the first transistor, and when the fourth transistor is turned off, the first capacitor is configured to store a threshold voltage of the first transistor.

10. The pixel circuit of claim 8, wherein, in a third period after the second period, the anode initialization gate signal has the active level, and the emission signal and the write gate signal have the inactive level.

11. The pixel circuit of claim 10, wherein, in the third period, the first capacitor maintains a threshold voltage of the first transistor.

12. The pixel circuit of claim 10, wherein, in a fourth period after the third period, the emission signal has the active level, and the write gate signal and the anode initialization gate signal have the inactive level.

13. The pixel circuit of claim 12, wherein, in the fourth period, the light emitting element emits light based on the driving current.

14. The pixel circuit of claim 3, wherein,
the first transistor includes the gate terminal connected to a first node, the first terminal connected to a second node, and the second terminal connected to a third node,
the light emitting element includes the anode connected to the third node and the cathode receiving a second power supply voltage,
the second transistor includes a gate terminal receiving the write gate signal, a first terminal connected to a data line providing the data voltage, and the second terminal connected to the first node,
the third transistor includes a gate terminal receiving the anode initialization gate signal, a first terminal connected to the third node, and a second terminal receiving the ground voltage,
the fourth transistor includes a gate terminal receiving the emission signal, a first terminal receiving the first power supply voltage, and a second terminal connected to the second node,
the first capacitor includes the first terminal connected to the second node and the second terminal connected to the first node, and
the second capacitor includes the first terminal connected to the first node and the second terminal receiving the anode initialization gate signal.

15. The pixel circuit of claim 3, further comprising:
a third capacitor including a first terminal receiving the first power supply voltage and a second terminal connected to the gate terminal of the first transistor.

16. The pixel circuit of claim 15, wherein the third capacitor includes the first terminal receiving the first power supply voltage and the second terminal connected to the first node.

17. A display device comprising:
a display panel including a pixel circuit,
wherein the pixel circuit includes:
a first transistor configured to generate a driving current;
a light emitting element including an anode connected to a second terminal of the first transistor and a cathode;
a second transistor connected to provide a data voltage to a gate terminal of the first transistor in response to a write gate signal;
a third transistor connected to provide a ground voltage to the anode in response to an anode initialization gate signal;
a first capacitor including a first terminal connected to a first terminal of the first transistor and a second terminal connected to the gate terminal of the first transistor; and
a second capacitor including a first terminal connected to the gate terminal of the first transistor and a second terminal receiving the anode initialization gate signal.

18. The display device of claim 17, wherein a back gate terminal of the first transistor receives a first power supply voltage.

19. The display device of claim 17, the pixel circuit further includes a fourth transistor connected to provide a first power supply voltage to the first terminal of the first transistor in response to an emission signal.

20. The display device of claim 19, wherein the first to fourth transistors are P-type transistors.
